(19) United States
(12) Patent Application Publication
(10) Pub. No.: US 2013/0138965 A1
(43) Pub. Date: May 30, 2013

(54) CONTROL METHOD, PROGRAM AND SYSTEM FOR LINK ACCESS

(71) Applicant: International Business Machines Corporation, Armonk, NY (US)

(72) Inventors: Kohichi Kamijoh, Tokyo (JP); Hisashi Miyashita, Kanagawa (JP); Hiroaki Nakamura, Tokyo (JP)

(73) Assignee: INTERNATIONAL BUSINESS MACHINES CORPORATION, Armonk, NY (US)

(21) Appl. No.: 13/752,964

(22) Filed: Jan. 29, 2013

Related U.S. Application Data
(63) Continuation of application No. 13/684,427, filed on Nov. 23, 2012.

(30) Foreign Application Priority Data
Nov. 25, 2011 (JP) JP2011-258300

(51) Int. Cl. H04L 9/30

(52) U.S. Cl. CPC H04L 9/30
USPC 713/176

(57) ABSTRACT

A plurality of users is assumed in which user A is the owner of content providing the source of a link, user B is the owner of the content providing the destination of the link, and user C is a viewer. Each user has a private key and a public key, and the public keys are shared by the users. User B selects user C in advance as a viewer. User B creates data including a value in which an encryption key with a proxy signature generated on the basis of the public key of user C and its own private key is encrypted using the public key of user A, and distributes the data to user A, which is the owner of the content providing the source of the link. User A decrypts the received data including the value using its own private key. This makes a function available based on encryption with the proxy signature. User A converts the link information using this function, signs the information using its own private key, and sends it to user C. User C verifies the signature by checking the received information using the public key of user A and the public key of user B, extracts the link information generated by user A using the function, decrypts it using its own private key, and obtains the link information.

### RELATED APPLICATION INFORMATION

This application is a Continuation application of co-pending U.S. patent application Ser. No. 13/684,427 filed on Nov. 23, 2012, incorporated herein by reference in its entirety.

### TECHNICAL FIELD

The present invention relates to access control for documents created on a computer and, more specifically, to access control to a document via a link inserted into another document.

### BACKGROUND

In the fields of product lifecycle management (PLM) and application lifecycle management (ALM) including CAD and bills of materials (BOM), related data (content) is frequently linked and referenced.

These days vendors of codevelopers and competitors are often interlinked, so there is sometimes a need to control access to other documents via links. The following conventional technologies are known to have been developed for this purpose.

Japanese Laid-open Patent Publication No. 4-326136 relates to the display of user-selectable information modules in a hypertext network used in an interactive data processing system. Hypertext networks include a plurality of user-selectable information modules. At least some of the modules include link reference clauses to other user-selectable target modules. A link reference clause to another user-selectable target module is identified in the selected information module in response to a selection entry from the user. The availability of other user-selectable target modules corresponding to the identified link reference clause is determined, and the identified link reference clause is selectively activated or deactivated depending on the determined availability of the other user-selectable target module. An identified link reference clause can be selectively activated or deactivated on the basis of user class or user permission. Then, the corresponding target module can be selected according to the identified user class.

An internet-connectable terminal device for sending and receiving email via the internet is disclosed in Japanese Laid-open Patent Publication No. 2008-287447 that includes a determination means for determining when received email is displayed whether a link from a link string included in a received email is valid or invalid, an extraction means for extracting a link string included in a received email in a case in which a link from a link string is determined to be valid, an identification and display means for identifying and displaying a link string extracted by the extraction means as a target link, and a control means for validating access via the internet to the link from a link string identified and displayed by the identification and display means, and invalidating access via the internet to the link from a link string not identified and displayed by the identification and display means.

In fields such as PLM/ALM, there is demand for the following functions. First, there are those who would like to know when a link has been attached to their own content from other content whether this has been attached by a third party with permission or not. There are also those who would like to be able to grant to a third party access to content when a third party has followed the link, requested access to the content from the owner, and the owner has checked access authorization for the user and has determined that the third party has access authorization. This is useful when one wants to protect the brand of certain parts, identify the origin of parts, or not link to certain parts from companies with a bad reputation.

In addition, there are situations in which one wishes to control who can see links to one's content in someone else's content. In this case, an owner of content including a link to one's own content may wish to be able to add access control as well. In other words, linked content can be viewed by someone only when someone has been given permission from both oneself and the owner of the content. For example, one may wish to display the existence of a plurality of parts to a certain company in link form, and references to links indicating which parts were made by which subcontractor may be kept confidential.

None of the conventional technologies can provide functions that meet all of these demands. However, the inventors in the present application have conducted research on encryption methods using so-called proxy signatures and have developed a technology in which an encryption method using a proxy signature has been applied to access control to a document from a link inserted in another document. This has been described in Japanese Laid-open Patent Publication No. 2011-97453 and Satoshi Hada, “Secure Obfuscation for Encrypted Signature”, Advances in Cryptology EUROCRYPT 2010.

### CITATION LIST

Japanese Laid-open Patent Publication No. 4-326136
Japanese Laid-open Patent Publication No. 2008-287447
Japanese Laid-open Patent Publication No. 2011-97453
Satoshi Hada, “Secure Obfuscation for Encrypted Signature”, Advances in Cryptology EUROCRYPT 2010

### SUMMARY OF INVENTION

An object of the present invention is to provide a technique enabling access control to a document via a link inserted into another document without communication between the owner of the linked content and the owner of the content in which the link was inserted.

The present invention has been proposed to solve this problem. In the present invention, it is first assumed that each user holds a private key and a public key in their computer. A private key is held only by the user, but the public key is disclosed to other users. In other words, the public keys of each user are stored in every computer.

Among the users, A and B refer to groups of owners of content that includes the source and destination of the link, respectively, and C refers to a group of viewers. SKa and Pka refer to the private keys and public keys of user a, Sign(X,Y) refers to Y signed using key X, and E(X,Y) refers to Y encrypted using key X.

In advance, bj(εB) selects group A′(⊂A) of people given permission to link to its own content, and group C′(⊂C) of people given permission to see the links. Then, Kaᵢbⱼcₖ=E (PKaᵢ,Kbⱼcₖ) is created for all combinations of {aᵢ(εA′) and ck(εC′)}, and distributed in advance to everyone included in A′. Kbⱼcₖ is a key for proxy signature encryption F(X). F(X) is a function described in Japanese Laid-open Patent Publication No. 2011-97453.

aᵢ(εA) receives Kaᵢbⱼcₖ from bⱼ and decrypts it using SKaᵢ to obtain Kbᵢcₖ. It is then able to calculate F(X)=E(PKck,Sign(SKbj,X)). (In proxy signature encryption, F(X) can be calculated using key Kbck). ai creates content x.doc, and selects viewers C″(⊂C′) given permission to see link x→y whose source and destination of the link are in x.doc and y.doc, respectively, created by bⱼ. σ=F(x→y)=E(PKcₙ, Sign (SKbⱼ,x→y)), and σ′=Sign (SKaᵢ, σ) are calculated for all cₙ(εC″), and σ′ is added to x.doc.

cn receives x.doc, uses PKai in σ′ to verify the signature of ai, and obtains σ. Then, σ is decrypted using SKcn to obtain σ″=Sign(SKbⱼ, x→y), the signature of bj is verified using PKbⱼ, and x→y is acquired.

cn sends a request for y.doc along with σ″ to bⱼ. After checking x→y and the signature in G″ using PKbⱼ, bⱼ sends y to cₙ. cₙ receives y, and embeds y in x.doc as a linked object.

The present invention enables access control of links without direct communication between the owner of a linked document and the owner of a document in which the link is inserted. It also enables the owners of documents in which the link is inserted to add control to those links at their sole discretion.

### BRIEF DESCRIPTION OF DRAWINGS

FIG. 1 is a diagram showing an example of coordination between different domains.

FIG. 2 is a diagram schematically showing a hardware configuration for implementing the cooperation between domains.

FIG. 3 is a diagram showing groupings based on user roles.

FIG. 4 is a block diagram of the hardware in a client computer.

FIG. 5 is a functional logic block diagram of a client computer.

FIG. 6 is a diagram showing the sub-modules of the encryption/decryption module.

FIG. 7 is a flowchart of the processing in the client computer of a user performed to create a document referenced in a link.

FIG. 8 is a flowchart of the processing in the client computer of a user performed to create a document in which a link is inserted.

FIG. 9 is a flowchart of the processing in the client computer of a user performed to reference a document referenced in a link.

FIG. 10 is a diagram schematically showing a specific example of the processing.

### DESCRIPTION OF PREFERRED EMBODIMENTS

The following is an explanation of an embodiment of the present invention with reference to the drawings. Unless otherwise noted, the same reference numerals refer to the same objects in all of the drawings. Explained below is an embodiment of the present invention. It should be understood that there has been no intention to limit the present invention to the content described in this embodiment.

First, the background of the invention will be explained. In fields such as the automotive, electronics and aerospace fields, the products are complicated and composed of many parts. Many domains (departments) contribute to the design of a single product, such as mechanical, electrical, system design, software, and testing domains. Even when these tasks are divided among several domains, everything eventually has to be integrated into a product. Therefore, data has to be exchanged between domains.

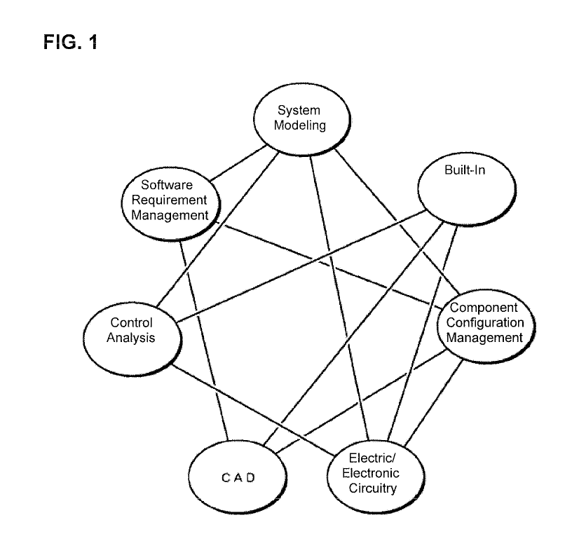

FIG. 1 is a diagram showing an example of coordination between different domains at a car manufacturer. In FIG. 1, data has to be exchanged between the different domains of system modeling, requirement management, control analysis, CAD, electric/electronic circuitry, component configuration management, and built-in software.

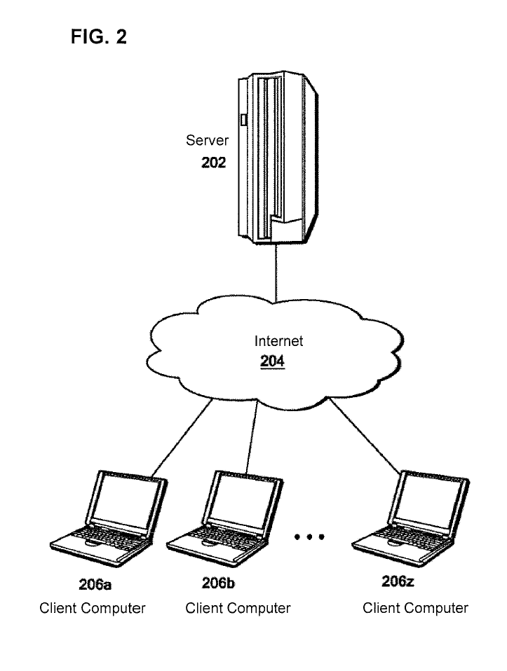

FIG. 2 is a diagram schematically showing a hardware configuration for implementing the cooperation between domains in FIG. 1. In FIG. 2, server 202 stores data shared by the domains, and is provided with a function enabling exchange of data between domains.

The client computers 206a, 206b, . . . 206z connected to the server 202 via the internet 204 preferably store data corresponding to each domain in FIG. 1. Each client computer 206a, 206b, . . . 206z possesses a unique private key, and a public key corresponding to the private key. The public key of each client computer 206a, 206b, . . . 206z may be disclosed to the public, but is preferably stored in the server 202 so that it can be accessed from any client computer 206a, 206b, . . . 206z.

In addition to the client/server configuration shown in FIG. 2, the processing of the present invention can be embodied using peer-to-peer connections between the client computers 206a, 206b, . . . 206z. In this case, the public keys of all of the client computers 206a, 206b, . . . 206z are preferably stored in each of the client computers 206a, 206b, . . . 206z.

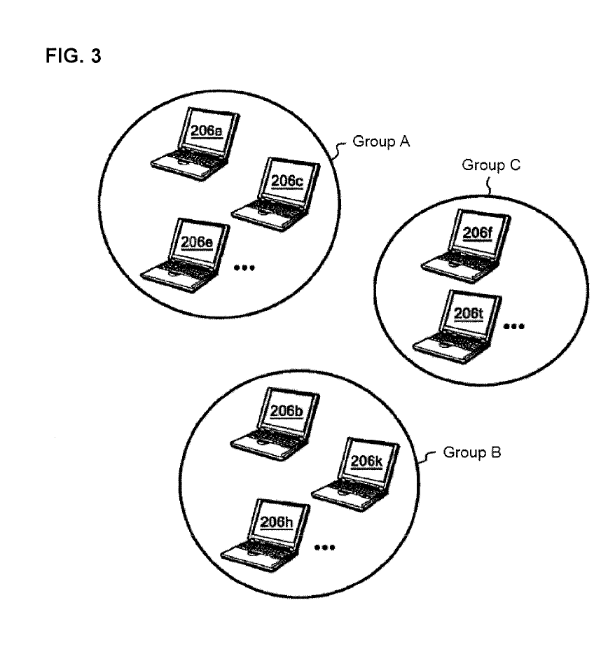

FIG. 3 is a diagram showing groupings of the client computers 206a, 206b, . . . 206z based on user roles in the context of the present invention. Here, the following type of document is used.

### XXXXXXXXXXXXXXXXXXXXXXXXXXXXXXXXXXXXXXXXXXXXXXXXXXXXXXXXXXXXXX

### XXXXXXXXXXXXXXXXXXXXXXXXXXXXXXXXXXXXXXXXXXXXXXXXXXXXXXXXXXXXXX

### XXXXXXXXXXXXXXXXXXXXXXXXXXXXXXXXXXXXXXXXXXXXXXXXXXXXXXXXXXXXXX

<ahref=“y.doc”>XXXXXXXXXXXXXXXXXXXXXXXXXXXXXXXXXXXXXXXXXXXX

### XXXXXXXXXXXXXXXXXXXXXXXXXXXXXXXXXXXXXXXXXXXXXXXXXXXXXXXXXXXXXX

When this is called x.doc, the group to which the client computers 206a, 206c, 206e, etc. belong that are used by the user who created x.doc or by the owner of x.doc is called group A. If necessary, a user in group A embeds a link such as <ahref=“y.doc”>XXX</a> in x.doc. The link information does not have to be embedded in x.doc. It can be held in a separate file containing link information. In this case, the viewer eventually embeds the link in x.doc after acquiring y.doc.

The group to which the client computers 206b, 206h, 206k belong that are used by the user who created y.doc referenced by a link embedded in x.doc or has link information in a separate file or by the owner of y.doc is called group B.

The group to which the client computers 206f, 206t, etc. belong that are used by the user viewing x.doc and if necessary requesting from user B a link embedded in the document or a document with link information in a separate file is called group C.

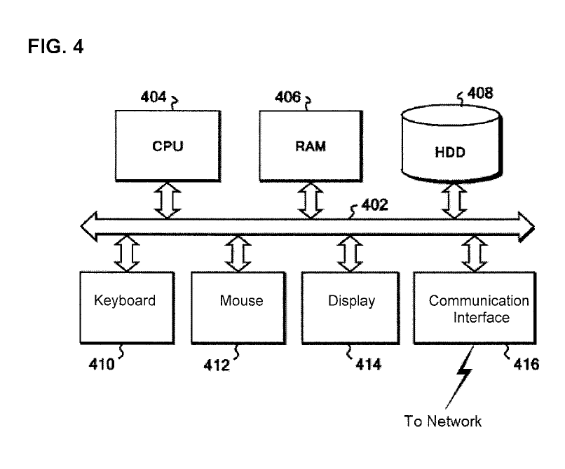

The hardware configuration of the client computers 206a, 206b, 206z shown in FIG. 2 is the same for the sake of convenience, and a block diagram of this configuration is shown in FIG. 4.

FIG. 4 is a block diagram of the computer hardware used to realize the system configuration and processing in an embodiment of the present invention. In FIG. 4, the CPU 404, the main memory (RAM) 406, a hard disk drive (HDD) 408, a keyboard 410, a mouse 412, and a display 414 are connected to a system bus 402. The CPU 404 is preferably based on 32-bit or 64-bit architecture. Examples that can be used include Pentium (trademark) 4, Core (trademark) 2 Duo, and Xeon (trademark) from Intel, and Athlon (trademark) from AMD. The main memory 406 preferably has a capacity of 4 GB or more. The hard disk drive 408 preferably has a capacity, for example, of 500 GB or more.

While not shown in the drawing, an operating system is installed beforehand in the hard disk drive 408. The operating system is compatible with the CPU 404 and can be Linux (trademark), Windows (trademark) 7 or Windows XP (trademark) from Microsoft®, or MacOS (trademark) from Apple Computer®.

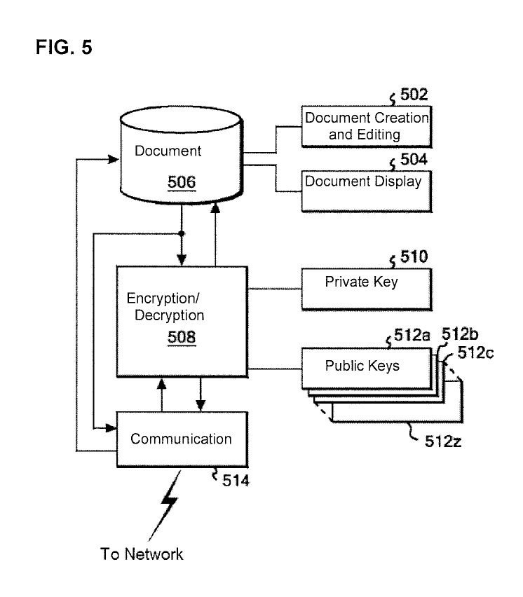

Also stored in the hard disk drive 408 is a document creation/editing program 502, a document display program 504, created documents 506, an encryption/decryption module 508, a private key unique to each user 510, a public key for each user 512a, 512b, . . . 512z, and a communication module 514. The configuration of these functions will be explained in greater detail later with reference to the block diagram in FIG. 5. The public keys 512a, 512b, . . . 512z do not have to be stored locally in the hard disk drive 408. They can be accessed on the server 202 via a communication interface 416.

The keyboard 410 and mouse 412 are used to operate a predetermined GUI screen (not shown), activate the document creation/editing program 502, etc., and enter text.

The display 414 is preferably a liquid crystal display and can have, for example an XGA (1024×768) or UXGA (1600×1200) resolution. The display 114 is used to display the workflow for the generated results.

The system shown in FIG. 4 is connected to an external network such as a LAN or WAN via a communication interface 416 connected to the bus 402. The communication interface 416 exchanges data with systems such as servers and client computers in external networks via mechanisms such as Ethernet (trademark).

The following is an explanation of the functional configuration in the embodiment of the present invention with reference to the functional block diagram in FIG. 5. The document creating/editing program 502 and the document display program 504 can both be provided by a single program. The document creating/editing program 502 can be a document creating/editing program such as Microsoft® Word or any general text editor.

The document 506 created by the document creating/editing program 502 can be in any document format that can embed links, including MS-Word format, HTML format, and XML format. The document display program 504 can be any program with functions enabling jumping to embedded links and the display of the content of links. This is typically provided by a Web browser.

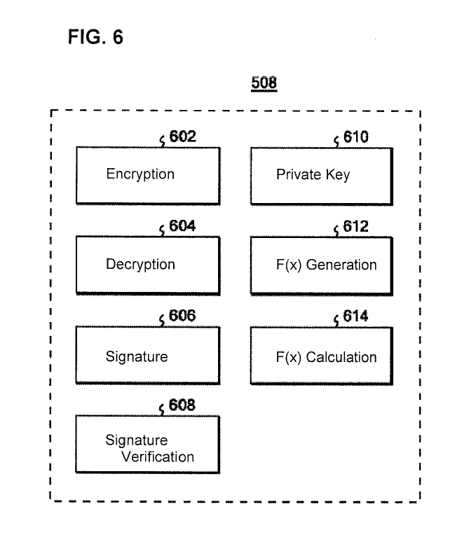

As shown in FIG. 6, the encryption/decryption module 508 includes an encryption sub-module 602, a decryption sub-module 604, a signature sub-module 606, a signature verification sub-module 608, a proxy signature encryption key generation sub-module 610, an F(X) generation sub-module 612, and an F(X) calculation sub-module 614.

The encryption sub-module 602, where, for example, the public key is PKaᵢ has a function in which X is encrypted from E(PKaᵢ,X) using public key PKaᵢ. For example, E(X,Y)=X̂Y or X to the Yth power using a certain modulo operation.

The decryption sub-module 604 has a function in which the data encrypted by encryption sub-module 602 is decrypted using the private key SKaᵢ corresponding to the public key PKaᵢ.

The signature sub-module 606 affixes a signature to X using Sign(SKaᵢ,X), where the private key is SKaᵢ.

The proxy signature encryption key generation sub-module 610, for example, generates encryption key with proxy signature Kbⱼcₖ using equation Kbⱼcₖ=R∥S′Kbⱼ. Here, R=E(PKcₖ,1/r), S′Kbⱼ=r*SKbⱼ, r is a random number generated by the client computer of user bjεB, where ∥ means concatenation, and * means multiplication.

The F(X) generation sub-module 612 provides F(X) using the equation F(X)=Sign(S′Kbⱼ,X)∥R.

The F(X) calculation sub-module 614, where X=a, calculates F(a) using the generated F(X), decrypts R, acquires 1/r, and verifies the signature using PKbⱼ/r.

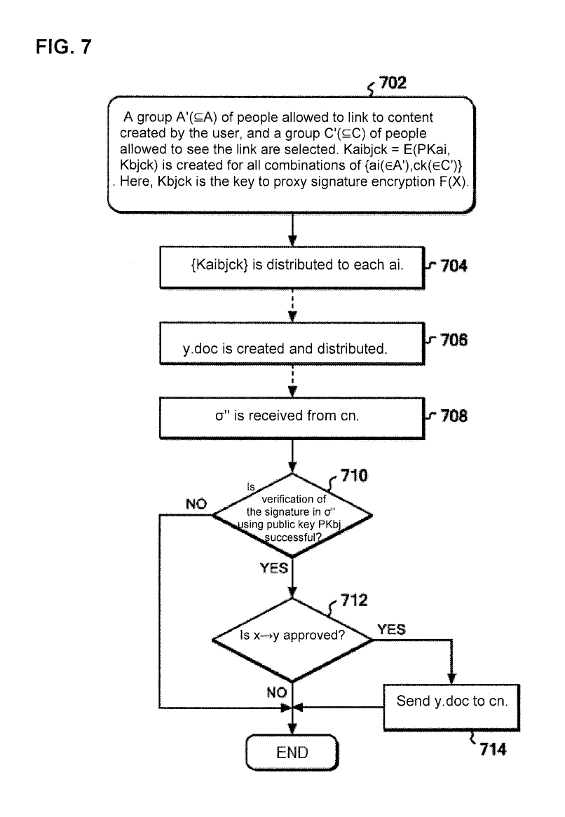

The following is a detailed explanation of how these sub-modules are used with reference to the flowcharts from FIG. 7 to FIG. 9.

The communication module 514 has a function of exchanging data with other client computers via the communication interface 416 and the server 202. Sometimes the document 506 is sent directly to the communication module 514. Sometimes the document 506, and data processed by the encryption/decryption module 508 using the private key 510 and each public key 512a, 512b, . . . 512z is sent to the communication module 514.

The communication module 514 receives documents 506 directly from other client computers via the communication interface 416 and the server 202. Results processed by the encryption/decryption module 508 are stored temporarily as a document 506.

The following is an explanation of the processing performed by a client computer in group B with reference to the flowchart in FIG. 7. In Step 702, the client computer selects a group A′(⊂A) of people allowed to link to content created by the user, and a group C′(⊂C) of people allowed to see the link. The client computer then calls up the proxy signature encryption creation sub-module 610 and creates Kaᵢbⱼcₖ=E(PKaᵢ,Kbⱼcₖ) for all combinations of {aᵢ(εA′),cₖ(εC′)}. Here, Kbjck is the key to proxy signature encryption F(X).

In Step 704, the client computer distributes {Kaᵢbⱼcₖ} to the client computer of each aᵢ.

In Step 706, the client computer creates y.doc, which is a recreated or existing document 506, and sends this to the client computers in group A.

Afterwards, the client computer receives σ″=Sign(SKbⱼ,x→y) from the client computer of user cn in group C. Here, x→y is link information embedded in document x.doc such as <ahref=“y.doc”>XXX</a> or link information included in a separate file.

In Step 710, the client computer that has the signature verification sub-module 608 attempts to verify σ″ using its own public key PKbj. When verification is successful, a menu asking the user whether or not to approve x→y is displayed on the display 414 in Step 712. When the user approves, y.doc is sent to the client computer of user cn in Step 714.

When verification fails in Step 710 or when the user does not approve x→y in Step 712, y.doc is not sent to the client computer of user en, and the process is ended.

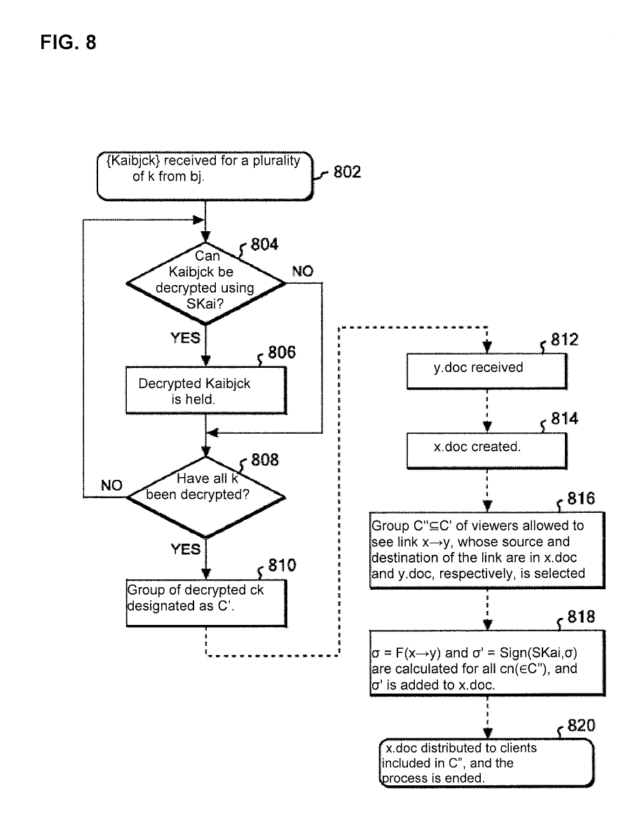

The following is an explanation of the processing performed by a client computer in group A with reference to the flowchart in FIG. 8.

In Step 802, the client computer in group A receives {Kaᵢbⱼcₖ} for a plurality of k from the client computer of user bjεB.

In Step 804, the client computer in group A calls up the decryption sub-module 604, attempts to decrypt Kaᵢbⱼcₖ using its own private key SKai. If decrypted, the decrypted Kbⱼcₖ is held in Step 806.

In Step 808, the client computer in group A determines whether or not all k have been decrypted. If not, the processing in Step 804 attempts the next k value.

When all k have been decrypted, the client computer in group A creates a group C′ of decrypted cn in Step 810.

In Step 812, the client computer in group A receives y.doc from a client computer in group B.

In Step 814, the client computer in group A uses the document creating/editing program 502 to create document x.doc. At this time, a link to document y.doc is placed in document x.doc such as <ahref=“y.doc”>XXX</a>

In Step 816, the user of the client computer in group A selects a group C″⊂C′ of viewers allowed to see link x→y, whose link source and destination are in x.doc and y.doc, respectively.

In Step 818, the user of the client computer in group A uses the F(X) generation sub-module 612 to generate F(X) for all cnεC″. Next, the F(X) calculation sub-module 614 is called up by the generated F(X), and σ=F(x→y)=E(PKcₙ,Sign(SKbⱼ,x→y)) is calculated. Next, the client computer in group A calls up the signature sub-module 606 to calculate σ′=Sign(SKaᵢ,σ), and σ′ is added to x.doc.

In Step 820, the user of the client computer in group A distributes x.doc to the clients included in C″, and the process is ended.

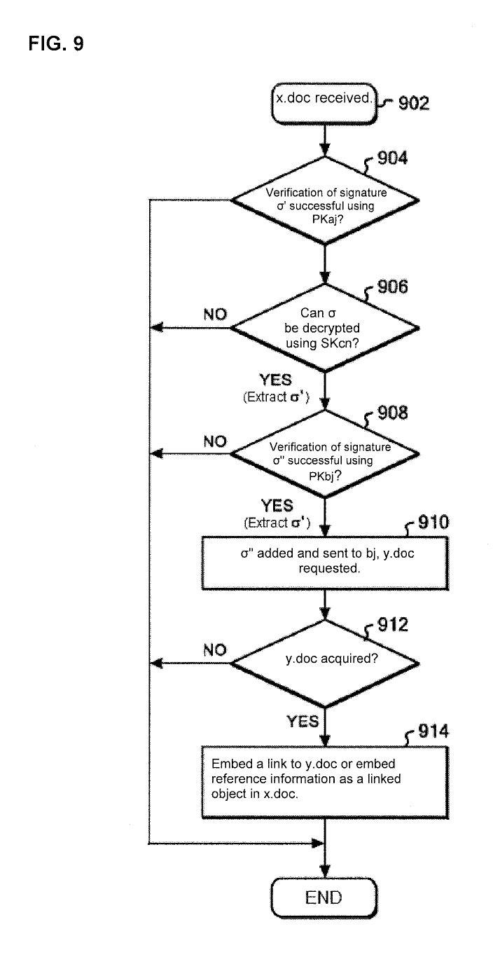

The following is an explanation of processing performed by a client computer in group C with reference to the flowchart in FIG. 9.

In Step 902, a client computer in group C receives x.doc from a client computer in group A. At this time, σ′ has been added and sent as explained with reference to Step 818.

In Step 904, the client computer in group C calls up the signature verification sub-module 608 and attempts to verify σ′ using PKaᵢ. If verification fails, the process is ended.

If the verification in Step 904 is successful, the client computer in group C calls up the decryption sub-module 604 and attempts to decrypt G using its own private key SKcn in Step 906. If decryption fails, the process is ended.

If the decryption in Step 906 is successful, the client computer in group C in Step 908 extracts σ″=Sign(SKbⱼ,x→y), calls up the signature verification sub-module 608, and attempts to decrypt σ″ using PKbⱼ. If verification fails, the process is ended.

If the verification in Step 908 is successful, the client computer in group C in Step 910 sends σ″ to the client computer of user bj and requests y.doc.

When σ″ has been received, the client computer of user bj responds to the successful verification in Step 710 by sending y.doc to the client computer in group C. Because the determination in Step 912 is positive, the client computer in group C in Step 914 embeds a link to y.doc or embeds a reference as a linked object in x.doc. If the verification in Step 710 has failed, y.doc is not sent and the process ends immediately.

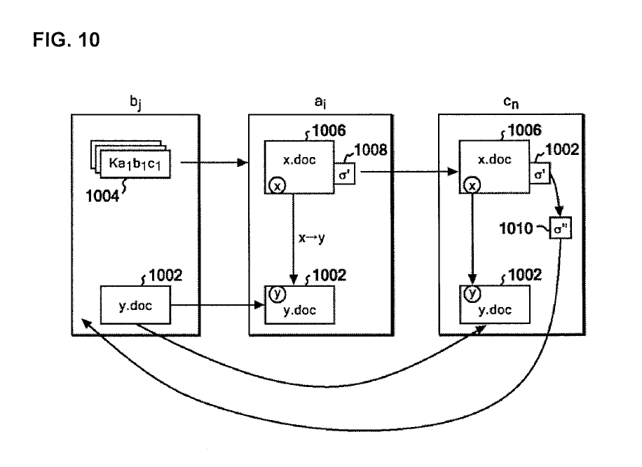

The following is an explanation of the proxy signature encryption process in the present invention with reference to FIG. 10. This realizes the safe request of the signature of a certain person (B) by a representative (A). At this time, the person viewing the signature (C) is identified by B. At the same time, it is essential that the signature of B be sent to agent (A) without divulging the private key of B to others.

The following is an explanation of a specific operation performed by the present invention with reference to the example in FIG. 10. In FIG. 10, bj is selected from group B, ai is selected from group A, and cn is selected from group C.

As shown in Step 702, bj creates {Kaibjck} 1004. As shown in Step 704, this is sent to ai. Next, bj creates document y.doc 1002 referenced by a link, and this is saved to the hard disk drive of the client computer.

In Step 802, ai receives {Kaᵢbⱼcₖ} 1004. In Step 812, content y.doc 1002 is received from bj. In Step 814, content x.doc 1006 is created. In Step 816, σ′ 1008 is created and added to x.doc. In Step 820, x.doc with σ′ attached is sent to cn.

In Step 902, cn receives x.doc with σ′ attached. In Steps 904-908, σ″ 1010 is extracted from σ′. In Step 910, σ″ 1010 is sent to bj.

In Step 710, after having received σ″ 1010, bj verifies σ″. In Step 714, it sends y.doc 1002 to cn.

cn inserts a link into y.doc 1002 or the reference into the spot for a link in x.doc 1006. Alternatively, y.doc 1002 can be saved in the same folder as x.doc 1006 so that a hyperlink to y.doc 1002 can be established from a spot for a link in x.doc 1006.

The present invention was explained above with reference to a specific embodiment. However, the computer system used in the present invention does not depend on a specific combination of hardware and software. It can be embodied using any platform or mode.

The encryption method used here was a typical RSA encryption method. However, the present invention is not limited to this method. Any public key encryption method, such as elliptic curve cryptography or ECDSA, can be used.

### REFERENCE NUMBERS LIST

404: CPU
406: Main Memory
408: Hard Disk Drive
502: Document Creation/Editing Program
504: Document Display Program
506: Document
508: Encryption/Decryption Module
510: Private Key
512a, 512b, . . . 512z: Public Key
602: Encryption Sub-Module
604: Decryption Sub-Module
606: Signature Sub-Module
608: Signature Verification Sub-Module
610: F(x) Generation Sub-Module
612: F(x) Calculation Sub-Module

What is claimed is:

1. A computer executed link access control program for a system in which a first user being an owner of a first document referenced by a document link, a second user being an owner of a second document in which the first document is embedded as a link, and a third user being able to view the first document embedded or to be embedded in a second document each have a private key and a public key in a computer, the public key of each user being shared with each user comprising:
a step for generating an encryption key with a proxy signature in the computer of the first user using the private key of the first user and the public key of the third user;
a step for encrypting the first key using the public key of the second user to obtain a first value;
a step for attaching a signature to value X using the private key of the first user, and generating function F(X) for encrypting it further with the public key of the third user using the encryption key with a proxy signature;
a step for subjecting information in the second document attaching a link to the first document to function F( ) to obtain a value, signing the value with the private key of the second user, and sending the information along with the second document to the computer of the third user; and
a step in the computer of the third user for receiving information signed using the private key of the second user along with the second document, verifying the signature in information signed using the private key of the first user with the public key of the second user, obtaining the value subjected to F( ), decrypting the value using the private key of the third user, verifying the decrypted value using the public key of the first user, and obtaining the information in the second document attaching a link to the first document.

2. The link access control program of claim 1, further comprising: a step in which the computer of the first user responds to receiving from the computer of the third user information signed using the private key of the first user by verifying the information signed using the private key of the first user with the public key of the first user and, when verified, sending the first document to the computer of the third user.

3. The link access control program of claim 1, wherein the computer of the first user, the computer of the second user, and the computer of the third user are connected to a server system, and wherein the computer of the first user, the computer of the second user, and the computer of the third user communicate via the server system.

4. The link access control program of claim 3, wherein the public key of each user is stored in the server system.

5. The link access control program of claim 1, wherein the computer of the first user, the computer of the second user, and the computer of the third user are connected peer-to-peer.

6. A computer implemented link access control system for a system in which a first user being an owner of a first document referenced by a document link, a second user being an owner of a second document in which the first document is embedded as a link, and a third user being able to view the first document embedded or to be embedded in a second document each have a private key and a public key in a computer, the public key of each user being shared with each user, comprising:
means for generating an encryption key with a proxy signature in the computer of the first user using the private key of the first user and the public key of the third user;
means for encrypting the first key using the public key of the second user to obtain a first value;
means for attaching a signature to value X using the private key of the first user, and generating function F(X) for encrypting it further with the public key of the third user using the encryption key with a proxy signature,
means for subjecting information in the second document attaching a link to the first document to function F( ) to obtain a value, signing the value with the private key of the second user, and sending the information along with the second document to the computer of the third user; and
means in the computer of the third user for receiving information signed using the private key of the second user along with the second document, verifying the signature in information signed using the private key of the first user with the public key of the second user, obtaining the value subjected to F( ), decrypting the value using the private key of the third user, verifying the decrypted value using the public key of the first user, and obtaining the information in the second document attaching a link to the first document.

7. The link access control system of claim 6, further comprising: means in which the computer of the first user responds to receiving from the computer of the third user information signed using the private key of the first user by verifying the information signed using the private key of the first user with the public key of the first user and, when verified, sending the first document to the computer of the third user.

8. The link access control system of claim 6, wherein the computer of the first user, the computer of the second user, and the computer of the third user are connected to a server system, and wherein the computer of the first user, the computer of the second user, and the computer of the third user communicate via the server system.

9. The link access control system of claim 8, wherein the public key of each user is stored in the server system.

10. The link access control system of claim 6, wherein the computer of the first user, the computer of the second user, and the computer of the third user are connected peer-to-peer.
